(19) United States
(12) Patent Application Publication
(10) Pub. No.: US 2006/0146734 A1
(43) Pub. Date: Jul. 6, 2006

(54) Method and system for low-delay video mixing

(75) Inventors: Stephan Wenger, Tampere (FI); Miska Hannuksela, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/029,901

(22) Filed: Jan. 4, 2005

(51) Int. Cl. H04L 12/16

(52) U.S. Cl. 370/260

(57) ABSTRACT

A method and system for compressed domain video mixing for spatially combining incoming video streams into an outgoing video stream. Using H.264 as an example, each incoming stream is divided into a plurality of slices, each having a plurality of header fields including a first_mb_in_slice header field. Based on the picture format in the outgoing stream, first_mb_in_slice for each incoming stream is modified such that the modified first_mb_in_slice header field is indicative of location in the spatial representation of the outgoing stream at which the slice of the incoming stream is placed. H.264's slice group mechanism is used to map the spatial positions of the second and following macroblocks of the slices to the appropriate locations. If the incoming streams are previously mixed by upstream mixers, a decomposer can be used to separate these mixed streams into component streams before combining them with other incoming streams.

### FIELD OF THE INVENTION

The present invention relates to video mixers in real-time sensitive communication systems, such as Multipoint Control Units (MCUs) for video conferencing systems, and to a picture decomposition system and method that constitute the inverse of the mixing process.

### BACKGROUND OF THE INVENTION

Traditionally, a video conferencing endpoint is designed to connect to another remote video conferencing endpoint in a point-to-point fashion. As depicted in FIG. 1, a sending endpoint 102 comprises a motion video source 101, such as a camera, and an encoder 103 to encode the video images from the video source into a video compressed stream. The video compressed stream is then sent through a network interface 104 over a network 105 to a single receiving endpoint 106. The receiving endpoint 106 comprises a network interface 107, a decoder 108 and a display device 109. The encoder 103 and the decoder 108 are often conforming to one of the known video compression formats such as H.264. As such, the receiving endpoint displays the information of the motion video source of the sending endpoint.

In order to allow for multi-point video conferencing, so-called multi-point control units (MCUs) are used. MCUs keep the endpoint architecture simple and move all multi-point functionality into the core network, where it traditionally resides in case of audio conferencing. An MCU consists of one or more MCU network interfaces, a control protocol implementation, a plurality of audio mixers, a plurality of video switchers or a plurality of video mixers, or a combination of the switches and mixers. For continuous presence MCUs, video switchers are not used.

FIG. 2 depicts a prior art multi-point video conferencing system. As shown, a plurality of sending endpoints 201, 202 use video sources, encoders, and network interfaces to convey a plurality of compressed video streams to an MCU 203. Inside the MCU 203, an MCU network interface 204 conveys the incoming compressed video streams to a video mixer 205, whereby the incoming compressed video streams are combined to form a single outgoing compressed video stream. The outgoing compressed video stream is conveyed through another MCU network interface 206 to the receiving endpoint 207.

It is possible that an MCU has a number of independent video mixers 208 so as to convey a plurality of outgoing compressed video streams to a plurality of receiving endpoints. If the receiving endpoints receive the same outgoing compressed video stream, each of the receiving endpoints displays the same set of processed incoming video streams.

A prior art video mixer is illustrated in FIG. 3. As shown, each of the incoming compressed video streams 301, 302 is separately reconstructed in a decoder 303, 304. Each of the reconstructed video streams forms an uncompressed image sequence 305, 306. Each uncompressed image sequence consists of individual pictures 307, 308 at a fixed or variable frame rate, which is normally identical to the sending frame rate of the sending endpoint. The individual pictures in each image sequence are scaled and clipped by a scaling/clipping mechanism 309, 310 to form a processed image sequence 311, 312. The scaling and clipping is performed in such a manner that the individual pictures in different processed image sequences can be arranged in a time-wise corresponding way to occupy different spatial regions of corresponding pictures in an outgoing image sequence. In FIG. 3, as an example, the first image sequence 305 is scaled down by a factor of two in both the X and Y dimensions, whereas the second image sequence 306 is mainly clipped. The processed image sequences 311, 312 are combined to form the outgoing image sequence 315 through an image assembly module 313 in accordance with configuration information 314. The configuration information 314 for the spatial arrangements of the pictures in the processed image sequences 311, 312 is normally static for the lifetime of a conference. The static configuration information is controlled by a user interface. There are also mechanisms that allow a dynamic reconfiguration in the framework of the ITU-T Rec. T.120, for example.

It should be noted that the spatial region of an individual picture in an outgoing image sequence can be smaller than, equal to or larger than a spatial region of any of the individual pictures 307, 308. The spatial relationship generally depends on the capabilities of the receiving endpoints and their network connectivity. In some prior art video mixers, overlapping of individual images in different incoming sequences is allowed. In others, such overlapping is not allowed.

It should also be noted that the video mixer can select a frame rate for the outgoing image sequence independently of the frame rate of the incoming video streams. The outgoing frame rate can be constant or variable, depending on the need of an application. Most prior art video mixers contain mechanisms to cope with different incoming frame rates and unsynchronized incoming video streams. For example, an individual picture in one of the incoming image sequences can be absent during the composition of an outgoing video sequence, this missing picture can be generated from one or more previous individual pictures, by copying or by extrapolation in the video mixer.

The outgoing image sequence 315 is compressed in the encoder 316 into an outgoing compressed video stream 317, using one of the commonly known video compression formats such as H.264, for example. As shown in FIG. 2, the outgoing compressed video stream is conveyed through the MCU network interface and the network, then to the receiving endpoint, where it is reconstructed and displayed. With video mixing, a user can view the combination of two or more video streams from several sending endpoints, without additional functionality at the receiving endpoint.

The video mixing technique in an MCU, as described above, requires a series of transcoding steps where income compressed video streams are reconstructed by one or more decoders into the spatial domain so that the scaling, clipping and assembling steps can be carried out in the spatial domain to form a combined image sequence. The combined image sequence is then compressed in an encoder to form an outgoing video stream. These decoding and re-encoding steps create a delay between sending and receiving of compressed video streams. They also degrade the image quality.

Video mixing and processing in the compressed domain can reduce delay and image degradation. Zhu et al. (U.S. Pat. No. 6,285,661) discloses a low-delay, real-time digital video mixing technique for multi-point video conferencing. As disclosed in Zhu et al., a plurality of segment processors are used in an MCU to extract segment data from a corresponding plurality of incoming compressed video streams. A plurality of data queues are used to store segment data provided by the segment processors so that a data combiner can be used to provide output data selectively provided by a controller. The video mixing technique, according to Zhu et al., uses a common intermediate format (CIF) of the H.261 standard where a CIF picture is partitioned into twelve groups of blocks (GOBs). Each GOB includes a plurality of macroblocks of data. Zhu et al. also uses the quarter CIF (QCIF) format where a picture is partitioned into three groups of blocks. Chen et al. (U.S. Pat. No. 5,453,780) discloses a method of combining four QCIF video input signals in the compressed domain to produce a merged CIF video output signal. Yona et al. (U.S. Patent publication 2003/0123537 A1) discloses a compressed domain mixing technique where macroblock address patching and pipelining is used. Chen et al. (U.S. Pat. No. 5,917,830) discloses a technique for splicing compressed, packetized digital video streams.

### SUMMARY OF THE INVENTION

The present invention provides a system and method to spatially mix several video bitstreams in the compressed domain and to decompose a video bitstream into several video bitstreams in the compressed domain.

In one embodiment of the invention, a plurality of sending endpoints generate a plurality of bitstreams of a spatial resolution that is required by a receiving endpoint, out of a plurality of source picture streams. Each of the bitstreams has to be generated out of the corresponding source picture streams in such a way that no motion vectors point outside of the spatial area of any source picture in the source picture streams, and that they follow other constraints dependent on a video compression technology employed (these constraints are outlined using an ITU-T Rec. H.264 compliant video coding as an example). The bitstreams are conveyed through a network to a video mixer, which is typically part of an MCU. The MCU can reside either in a core network or in the receiving endpoint. In the video mixer, a spatial slice group allocation scheme depending on the employed video compression standard is used to spatially assign a plurality of macroblocks to their desired positions in a reconstructed picture in a receiving endpoint. The video mixer takes a coded incoming picture from each of the plurality of the incoming streams, and patch identification and spatial information of the incoming coded pictures so that the coded incoming pictures are concatenated and combined to form a single outgoing coded picture. Finally, the outgoing coded picture is sent to the receiving endpoint for reconstruction.

In another embodiment of the present invention, the MCU uses a plurality of mixers to combine a plurality of incoming streams into a plurality of outgoing streams. Each of the mixers mixes one or more of the plurality of incoming streams in the MCU, to exactly one outgoing video stream. Each of the plurality of mixers has local configuration information for mapping of a plurality of spatial regions, which indicates the spatial locations at which the incoming streams are placed. This allows users at the receiving terminals to view the pictures on the streams provided by the MCU according to their own, independent configuration. This embodiment may require the sending endpoint to generate more than one representation of the same captured image, at different spatial resolutions, so as to fulfil the requirements by the configuration information of the mixers. This embodiment of the present invention is related to the simulcast technology.

In a different embodiment of the present invention, an MCU also contains a decomposition system. The decomposition system may receive its input stream from an output of another MCU that generates a mixed video stream, as discussed above. The decomposition system decomposes an incoming mixed stream into a plurality of outgoing decomposed streams. These outgoing decomposed streams can be used as input streams for the mixers in the MCU. This embodiment of the present invention is related to the cascaded MCU technology

In yet another embodiment of the present invention, a video mixer is part of an endpoint. The incoming streams of the video mixer are received from a network interface or from a multiplexer. The outgoing stream of the video mixer is connected to a network interface, or a multiplexer, and/or to a video decoding subsystem of the endpoint. This embodiment of the present invention is related to the endpoint-based MCU functionality.

It is possible that the decomposition system is not part of an MCU, but of a system that implements a different functionality such as a real-time video editing table.

It is also possible that the mixer is not part of an MCU or part of a video conferencing endpoint, but of a system that implements a different functionality such as a real-time video editing table.

Thus, the first aspect of the present invention provides a method of video mixing in compressed domain for combining a plurality of first video bitstreams into at least one second video bitstream having a plurality of frames, each of the first bitstreams having a plurality of corresponding frames. The method comprises:

dividing each of the first video bitstreams into a plurality of slices, each of the slices having a slice header including a plurality of header fields;

changing one or more of the plurality of header fields in the slice header for providing a changed slice header in at least some of the slices;

providing a changed slice for each of said at least some of the slices; and

generating the second video bitstream based on the changed slices, wherein the changed slice for use in each of the frames in the second video bitstream is corresponding to a same frame in the plurality of corresponding frames in the first video bitstreams.

According to the present invention, said one or more of the plurality of header fields comprise a frame_num header field.

According to the present invention, said one or more of the plurality of header fields comprise a first_mb_in_slice header field and first_mb_in_slice has a value indicative of location of said each slice in a spatial region in a spatial representation of the first video bitstreams.

According to the present invention, the first_mb_in_slice header field is changed by changing said value of first_mb_in_slice to a new value indicative of the location of the corresponding changed slice in a spatial region in a spatial representation of the second video bitstream.

According to the present invention, said new value of first_mb_in_slice is calculated as follows:
first_mb_in_slice=ypos*xsize_o+(mbpos_i/xsize_i)*xsize_o+xpos+(mbpos_i % xsize_i),
wherein

/ denotes division by truncation;

% denotes a modulo operator;

xsize_i denotes a horizontal size of the spatial region in the spatial representation of the first video bitstream;

xsize_o denotes a horizontal size of the spatial region in the spatial representation of the second video bitstream;

xpos, ypos denote coordinates of a location in the spatial representation of the second video bitstream for placing said spatial region in the spatial representation of the first video bistream; and

mbpos_i denotes said value of first_mb_in_slice.

According to the present invention, the method further comprises transforming the second video bitstream for providing a spatial representation of the second video bitstream.

According to the present invention, the method further comprises identifying the slices in the first video bitstreams so as to allow the changed slices in the same frame to be combined into one of the frames in the second bitstream.

According to the present invention, one or more of the first video bistreams comprise a mixed bitstream composed from a plurality of further video bistreams. The method further comprises decomposing the mixed bitstream for providing a plurality of component video bitstreams, each of the component video bitstreams corresponding to one of the further video bistreams, so as to allow the component video bitstreams to be combined with one or more other first video bitstreams for generating the second video bitstream.

According to the present invention, said generating comprises mapping the plurality of slices of at least one of said plurality of first video bitstreams to at least one of a plurality of non-overlapping rectangular areas in a spatial representation of the second video bitstream.

According to the present invention, said first and second video bitstreams conform to H.264 standards, and said mapping is based on H.264's slice group concept.

Alternatively, said first and second video bitstreams conform to H.263 with Slice Structured Mode (SSM, defined in Annex K), sub-mode Rectangular Slices, enabled, and Independent Segment Decoding mode (ISM, defined in Annex R) enabled; and an SSM mechanism is used to map the plurality of slices of at least one of said plurality of first bitstreams to at least one of a plurality of non overlapping rectangular spatial areas in said reconstructed second bitstream.

The second aspect of the present invention provides a procedure for video mixing in compressed domain for combining a plurality of first video bitstreams into at least one second video bistream, each of the first video bitstreams and the second video bitstream having an equivalent spatial representation, wherein the second video bitstream comprises a plurality of second slices, each second slice having a slice header including a plurality of header fields, and wherein each of the first video bitstreams comprises a plurality of first slices, each first slice having a slice header including a plurality of header fields. The procedure comprises the steps of:

parsing the slice header of the first slices for obtaining values in the plurality of header fields, wherein one of the values is indicative of a spatial region in the spatial representation of the corresponding first video bitstream;

modifying said one of the values for providing a new value indicative of a spatial region in the spatial representation of the second video bitstream;

generating a new slice header based on the new value for providing a modified first slice; and

combining the first video bitstreams into said one second video bitstream such that each of the second slice in the second video bitstream is composed based on the modified first slice of each of first video bitstreams.

According to the present invention, said one of the values is first_mb_in_slice indicative of location of a first slice in the spatial region in the spatial representation of the corresponding first videostream, and the new value of first_mb_in_slice is calculated as follows:
first_mb_in_slice=ypos*xsize_o+(mbpos_i/xsize_i)*xsize_o+xpos+(mbpos_i % xsize_i),
wherein

/ denotes division by truncation;

% denotes a modulo operator;

xsize_i denotes a horizontal size of the spatial region in the spatial representation of the first video bitstream;

xsize_o denotes a horizontal size of the spatial region in the spatial representation of the second video bitstream;

xpos, ypos denote coordinates of a location in the spatial representation of the second video bitstream for placing said spatial region in the spatial representation of the first video bistream; and

mbpos_i denotes said value of first_mb_in_slice.

According to the present invention, one or more of the first video bistreams comprise a mixed bitstream composed from a plurality of further video bistreams. The procedure further comprises the step of:

decomposing the mixed bitstream for providing a plurality of component video bitstreams, each of the component video bitstreams corresponding to one of the further video bistreams, so as to allow the component video bitstreams to be combined with one or more other first video bitstreams for generating the second video bitstream.

The third aspect of the present invention provides a video mixer operatively connected to a plurality of sending endpoints to receive therefrom a plurality of first video bitstreams for combining in compressed domain the plurality of first video bitstreams into at least one second video bitstream having a plurality of frames, each of the first bitstreams having a plurality of slices in a plurality of corresponding frames, each slice having a slice header including a plurality of header fields. The mixer comprises:

a mechanism for changing one or more of the plurality of header fields in the slice header for providing a changed slice in at least some of the slices based on the changed one or more header fields; and

a mechanism for combining the changed slices for providing the second video bitstream, wherein the changed slices for use in each of the frames in the second video bistream is corresponding to a same frame in the plurality of corresponding frames in the first video bitstreams.

According to the present invention, said one or more of the plurality of header fields comprise a first_mb_in_slice header field and wherein first_mb_in_slice has a value indicative of location of said slice in a spatial region in a spatial representation of the first video bitstreams; the first_mb_in_slice header field is changed by changing said value of first_mb_in_slice to a new value indicative of location of said changed slice in a spatial region in a spatial representation of the second video bitstream; and said new value of first_mb_in_slice is calculated as follows:
first_mb_in_slice=ypos*xsize_o+(mbpos_i/xsize_i)*xsize_o+xpos+(mbpos_i % xsize_i),
wherein

/ denotes division by truncation;

% denotes a modulo operator;

xsize_i denotes a horizontal size of the spatial region in the spatial representation of the first video bitstream;

xsize_o denotes a horizontal size of the spatial region in the spatial representation of the second video bitstream;

xpos, ypos denote coordinates of a location in the spatial representation of the second video bitstream for placing said spatial region in the spatial representation of the first video bistream; and

mbpos_i denotes said value of first_mb_in_slice.

According to the present invention, said combining comprises mapping the plurality of slices of at least one of said plurality of first video bitstreams to at least one of a plurality of non-overlapping rectangular areas in a spatial representation of the second video bitstream.

The fourth aspect of the present invention provides a signaling method for use in a communication network in support of the method as claimed in claim 1, wherein the communication network comprises a plurality of sending endpoints to provide the plurality of first video bitstreams and at least one receiving endpoint to receive said at least one second video bitstream. The signaling method comprises the steps of:
Step 1: negotiating a picture format for use by the receiving endpoint and the sending endpoints;
Step 2: sending control information to the receiving endpoint in order to prepare the receiving endpoint for the receiving of said second video bitstream.

According to the present invention, said negotiating in Step 1 comprises:
generating a layout of the picture format for the receiving endpoint;
identifying at least one picture format based on said layout for each of the plurality of sending endpoints; and
   informing the plurality of sending endpoints of said identified picture format for each of the plurality of sending endpoints.

According to the present invention, said negotiating in Step 1 further comprises: receiving one negotiated picture format from each of the plurality of the sending endpoints in response to said informing; and each of the plurality of the sending endpoints provides a parameter set containing information indicative of said one negotiated picture format, and wherein said sending in Step 2 further comprises the step of

generating an output parameter set based on said information provided by each of the plurality of sending endpoints so as to provide the control information to the receiving endpoint based on the output parameter set.

The present invention will become apparent upon reading the description taken in conjunction with FIGS. 4-7.

### BRIEF DESCRIPTION OF THE DRAWINGS

FIG. 1 illustrates a prior art point-to-point video conferencing system.

FIG. 2 illustrates a prior art multi-point video conferencing system.

FIG. 3 is a schematic representation showing the process of video mixing in a prior art multi-point video conferencing system.

FIG. 4 is block diagram showing the process of video mixing in a multi-point video conferencing system, according to the present invention.

FIG. 5 is a flowchart depicting the mixing operation, according to the present invention.

FIG. 6 is a protocol diagram illustrating the sequence of events in the signaling and startup procedure among the sending endpoint, the mixer and the receiving endpoint, according to the present invention.

FIG. 7 is a schematic representation showing a system for video stream decomposition in a cascade MU configuration.

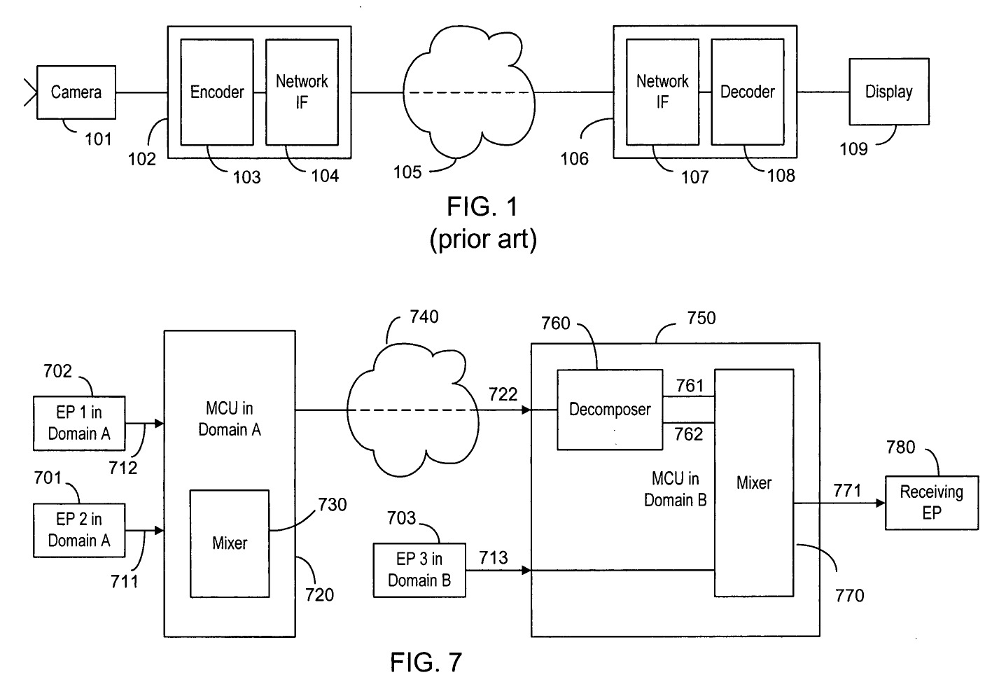

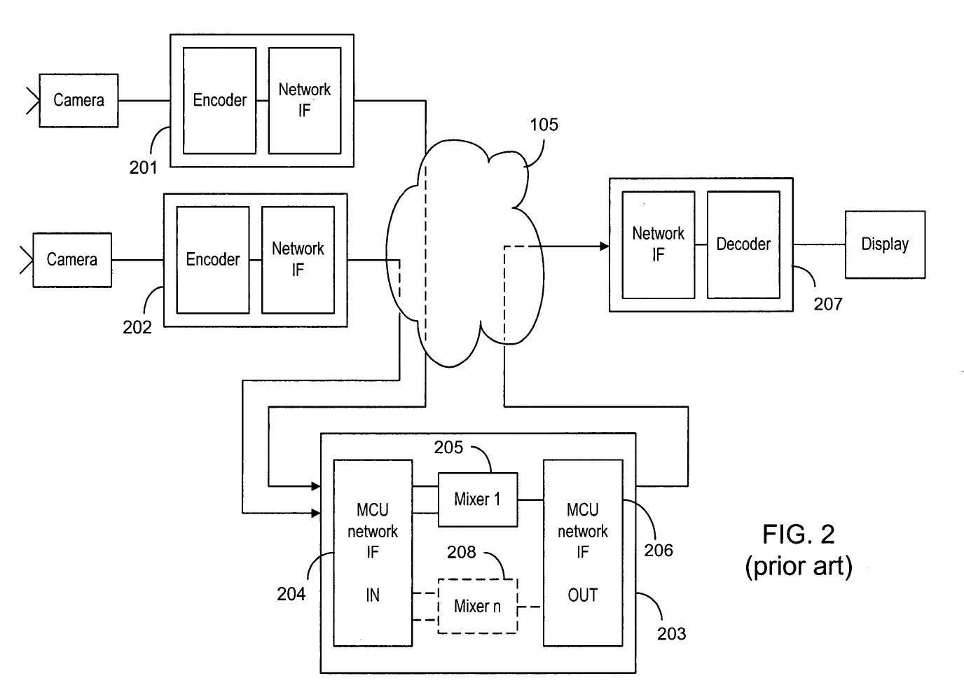

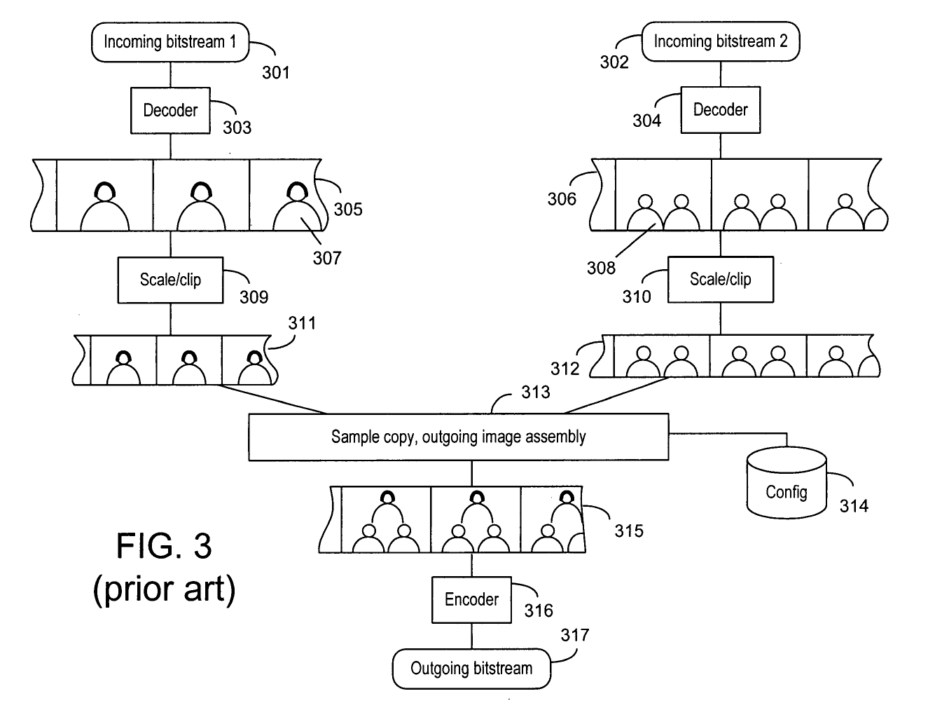

### DETAILED DESCRIPTION OF THE INVENTION

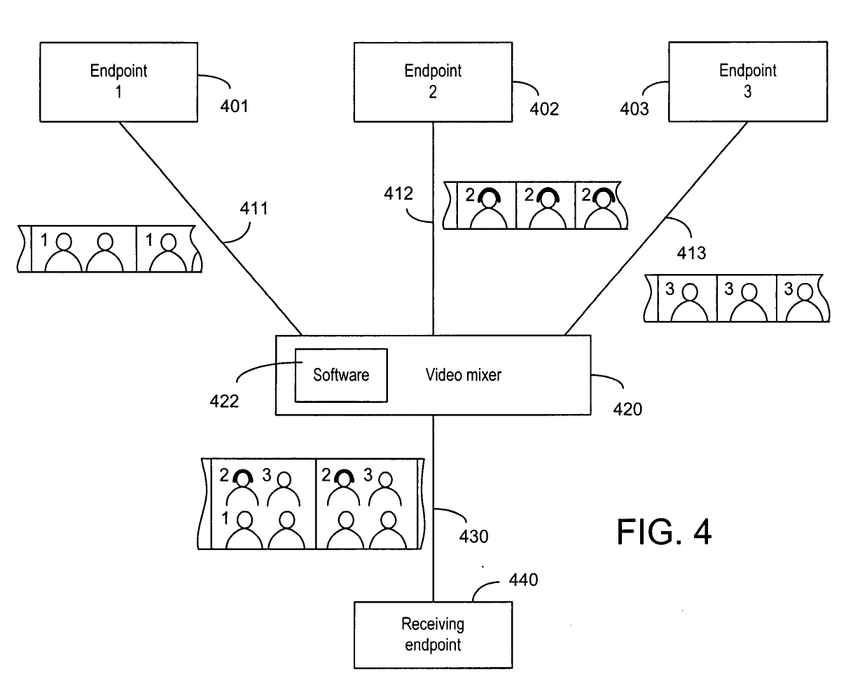

In one of the embodiments of the present invention, a video mixer is used to mix a plurality of incoming video bitstreams conforming to the ITU-T Rec H.264 baseline profile into one bitstream, which is also conforming to ITU-T Rec. H.264 baseline profile. Referring to FIG. 4, for example, three compressed video streams 411, 412, 413 are created independently by three different endpoints 401, 402, 403 in three different locations. The spatial representation of the three video bitstreams 411, 412, 413 can be different from each other. In this example, the first endpoint 401 sends a video bitstream 411 in which the spatial representation is twice as wide than the spatial presentation in the video bitstreams 412, 413 of the other endpoints 412, 413. However, the spatial presentation in each of the bitstreams 411, 412, 413 is of the same height. Note that the video bitstreams are compressed, for example, according to the baseline profile of ITU-T Rec. H.264. Thus, the properties of the spatial representation are available in compressed form only. The three video bitstreams 411, 412, 413 are mixed in the compressed domain by a video mixer 420 to form an outgoing compressed video stream 430. The outgoing compressed video stream 430 may comprise information from all three incoming bitstreams 411, 412, 413. For example, the spatial representation of the incoming bitstream 411 is present in the bottom half of the spatial representation of in the outgoing bitstream 430. In order to achieve such spatial presentation in the outgoing video bitstream, the spatial representations of the incoming video bitstreams have to be of such size that they spatially fit into the spatial representation of the outgoing bitstream. The overlapping of the component spatial representations in the outgoing video bitstream is on a macroblock basis, and not determined on a pixel by pixel basis. This embodiment uses the ITU-T Rec. H264 baseline, where the macroblock size is 16×16 pixels. Thus, each of the spatial regions of the incoming pictures is placed in pixel positions that are divisible by 16.

The video mixing, according to this embodiment, requires a number of constraints to be placed on the generation and transmission of the incoming video signals. Some of these constraints can be relaxed in other embodiments, but the relaxation of constraints may increase complexity in implementation and computation.

It should be understood that, in this embodiment, the term “video bitstreams conforming to H.264” implies error free transmission. Thus, in the baseline profile, the frame_num increases by one for each picture received from the incoming streams, and every macroblock of each picture is represented in exactly one slice. This embodiment further requires a fixed, constant, and identical picture rate from each of the incoming bitstreams, and that, except for one initial Instantaneous Decoder Refresh (IDR) picture, the incoming bitstreams do not include IDR pictures in the sense of subclause 8.2.1 and connected sub-clauses of H.264. The initial IDR picture is the first picture transmitted in each sub-picture. Furthermore, this embodiment requires that such IDR pictures arrive at such a time that they can be mixed into a single outgoing IDR picture. It should be noted that such requirements on the constraints can be commonly met, for example, in medium to high bandwidth, ISDN based video conferencing.

Other preconditions of the incoming bitstreams include the further restrictions as follows:

a) Parameter Set Information:

A1) All slice headers of all incoming streams reference only a single picture parameter set, with the same pic_parameter_set_id used in all slice headers

A2) The referenced picture parameter sets are identical in all their values, with the additional constraints mentioned below in A3 through A5:

A3) In the picture parameter set, the pic_order_present_flag is OFF

A4) In the picture parameter set, num_slice_groups_minus1 is 0

A5) In the picture parameter set, deblocking_filter_control_present_flag is ON

A6) The referenced sequence parameter sets are identical with the exceptions and constraints mentioned below in A7 through A9:

A7) pic_order_cnt_type is 2

A8) pic_widths_in_mbs_minus1 is set to the width of the picture in macroblock units as per H.264

A9) pic_height_in_map_units_minus1 is set to the height of the picture in macroblock units as per H.264

b) NAL (Network Abstraction Layer) Unit Header Information—the Following Should be Noted:

NAL units of type 1 are modified in the slice header and forwarded otherwise untouched. NAL units of type 5 (IDR) require some special signaling and are otherwise handled as NAL units of type 1. NAL units of type 6 to 12 are intercepted by the mixer and handled locally. The result of this handling process may be the generation of NAL units of types 6-12 in the outgoing bit stream. All other NAL unit types cannot occur in a conformant H.264 baseline stream.

c) Slice Header Information

C1) first_mb_in_slice must conform to H.264. It should be noted that first_mb_in_slice is modified during the mixing process to reference the position of the first macroblock in the slice of the newly generated mixed picture.

C2) The slice type must be 0, 2, 5, or 7. It should be noted that slice types 5 and 7 are converted to slice type 0 and 2 respectively, during the mixing process.

C3) It should be noted that frame_num is modified during the mixing process so that all sub-pictures of a mixed picture have the same frame_num.

C4) disable_deblocking_filter_idc must be 1 (filter disabled completely) or 2 (filter disabled at slice boundaries). Note that this implies condition A5 above.

d) Lower Layers (Macrobloc, Block)

No restrictions beyond those mentioned above.

e) VUI (Video Usability Information) and HRD (Hypothetical Reference Decoder) Parameters (Sequence Parameter Set Extensions)

The incoming bitstreams may contain VUI and HRD information in their single referenced sequence parameter set. Smart mixer implementations could make use of some of the values present in these data structures, but in this embodiment the sequence parameter set generated by the mixer does not generate the sequence parameter set extensions containing VUI and HRD information.

Basic Mixing Operation

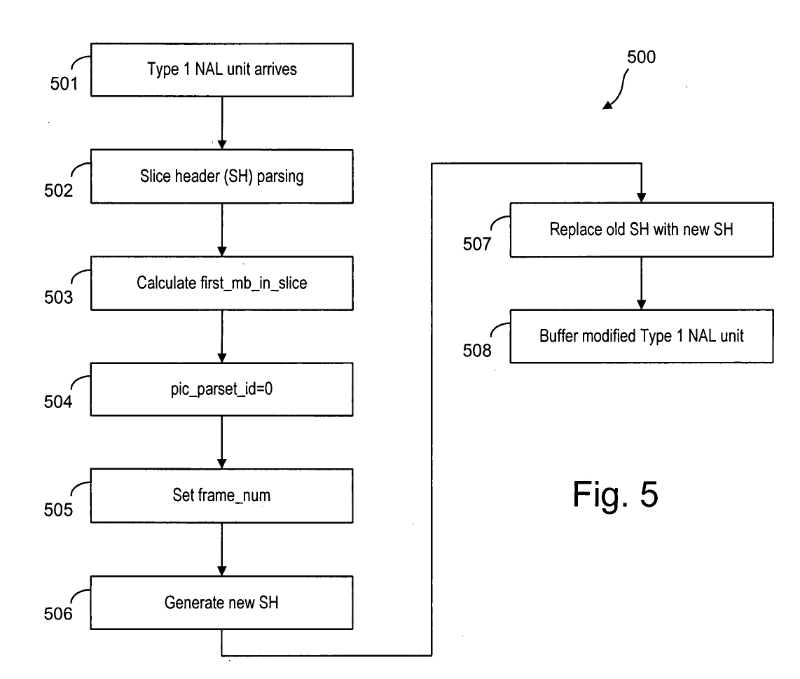

The following description of the basic mixing operation assumes that the parameter sets have already been transmitted by the mixer—the generation and sending of the parameter sets will be discussed later. The basic mixing operation is depicted in FIG. 5 in the form of a flowchart.

As shown in the flowchart 500, whenever a NAL unit from one of the incoming bit streams arrives at the mixer (step 501), the mixer first handles NAL units of types other than 1 in a special manner as discussed earlier. If the nal_unit type is 1, then a regular slice has arrived that should be processed.

First, the slice header is parsed (step 502). Values are stored for further processing. It is assumed that the variable names used are identical to those of the syntax elements in accordance with the description in section 7.3.3 of H.264. The bit exact position of the first syntax element not belonging to the slice header is stored as well.

The new value for first_mb_in_slice is calculated as follows (step 503):

Let xsize_i be the horizontal size of the spatial region of the reconstructed incoming stream, measured in units of macroblocks (16 pixels)

Let xsize_o be the x horizontal size of the spatial region of the generated mixed stream, measured in units of macroblocks (16 pixels)

Let xpos, ypos be the x and y position, respectively, of the top, left macroblock of the “window” in the spatial representation of the outgoing stream, into which the spatial representation of the incoming stream should be copied.

Let mbpos_i be the previous value of first_mb_in_slice in the incoming bit stream.

In the following, the / symbol denotes division with truncation, the % symbol denotes the modulo operation, text in a line after the // symbol denotes a comment (c++ syntax):

| first_mb_in_slice = | |
|---|---|
| ypos * xsize_o+ | // macroblocks in the lines above the |

“window”

| (mbpos_i / xsize_i) * xsize_o+// lines in the “window” | |
|---|---|
| xpos + | // macrobock columns left of the “window” |

| | |
|---|---|
| (mbpos_i % xsize_i); | // columns in the “window” |

The pic_parameter_set_is set to 0 (step 504).

The new value for first_mb_in_slice can be calculated by a software program 422 (see FIG. 4), for example.

The frame_num is set to an appropriate value (step 505). In this embodiment, the timing information of the network layer and the eventual frame skips in the encoders of the incoming bitstreams are not taken into account. In this embodiment, frame_num is set to the frame_num of the next outgoing picture (in other embodiments, frame_num could be set to values higher than the frame_num of the outgoing picture and the nal_unit could be delayed in the queue until it is time to send it).

All other values of the slice header's syntax elements are kept unchanged.

Using the (modified) values of the slice header syntax elements, a new slice header conformant to the H.264 specification is generated (step 506). This slice header is concatenated with the non-slice-header data of the NAL unit (step 507). The start of this non-slice-header data is stored during the parsing of the slice header. If padding at the end of the newly generated slice is needed, this can be carried out according to the syntax specification of H.264 (see rbsp_slice_trailing_bits ( ) in the H.264 specification).

It should be noted that this concatenation process requires bit-oriented operations, but those operations are much less computationally intensive than the operations required to reconstruct the bitstream to its spatial domain.

The newly generated slice is kept in a buffer until it can be sent out with the other slices that carry the same frame_num (508).

The software program 422 in the mixer 420 (FIG. 4) can also be used to carry out one or more other steps in the mixing operations. For example, the software program 422 also has pseudo codes for parsing the slice header and storing the values in the slice header fields for further processing; setting frame_num and generating new slice header. The same software program can be used to divide a video bistream into slices, modify the header fields and combine a plurality of incoming video streams to an outgoing video streams.

Signaling, Parameter Set Generation and Operation

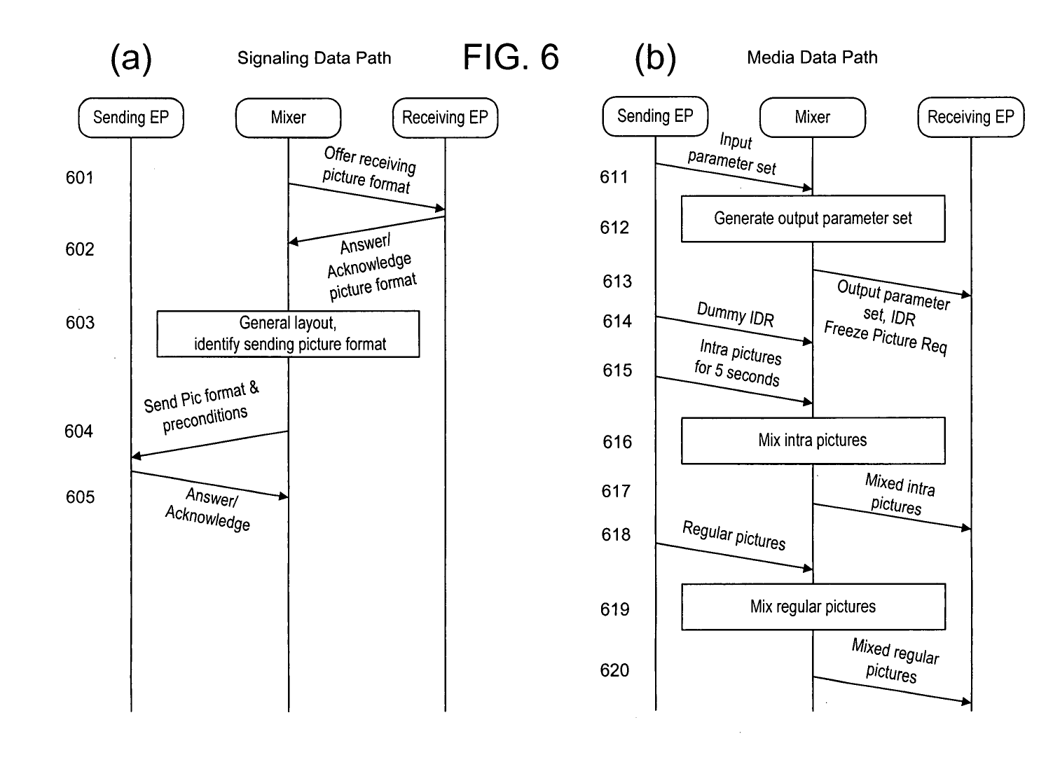

In order to meet the requirements for the bitstreams of this embodiment, signaling support is required beyond that of a point-to-point call. Furthermore, the startup procedure of the media stream differs slightly from the one in a point-to-point case. The signaling and startup procedure is depicted in FIG. 6 in the form of a protocol diagram, which is disclosed as follows:

In Signaling Data Path

1. The receiving endpoint(s) and the mixer negotiate on the receiving picture format, using an offer-answer protocol, for example (step 601).
2. With this information, and information from the user interface or conference configuration protocols or applications, such as CPCP (Conference Policy Control Protocol, Internet Draft, work in progress), the mixer can generate the layout of the receiving picture format and hence also the required input formats from the sending terminals (step 602). These required picture formats are communicated to the sending terminals (step 603), using the normal capability exchange process. Note that H.264 requires senders to be very flexible in terms of supported picture formats below the maximum format supported. In the same step, the sending terminals also need to be informed that they must generate streams conforming to the “Preconditions” mentioned above. This step finalizes the startup with respect to the signaling protocol. The remaining steps of the startup are handled on the media level and commence only after the signaling level operation is completed.

In Media Data Path
3. The sending terminals begin with the sending of the single picture and sequence parameter set (step 604).
4. Based on the received parameter sets and the configuration, the mixer generates a single picture parameter set and a single sequence parameter set containing a slice group map consistent with the configuration information. These parameter sets are sent to the receiving endpoint (step 605). Furthermore, a logo to be added to the mixed picture can be sent in an IDR picture containing the logo as content to the receiving endpoint, together with a freeze picture request (to freeze the logo until meaningful mixed content is available) (step 605).
5. The sending terminals send a single IDR picture, as required by H.264 to the mixer. The content of the IDR picture may be random—it is not used for further processing (step 606).
6. Following the dummy IDR picture, the sending endpoints start sending Intra pictures to the mixer (step 607).
7. As soon as all endpoints have sent the Intra pictures synchronously (after any startup or constant network delay), the mixer mixes the first intra picture and sends it to the receiving terminal, along with a freeze picture release (step 608).
8. After a predetermined time period, the endpoints switch to sending regular inter coded pictures (step 609). In this embodiment, the predetermined time period is five seconds. However this time period can be significantly reduced once experimental results of the network conditions are available (it would also be possible to add signaling support so that the endpoints report to the mixer that they are ready).
9. The mixer mixes the regular inter coded pictures and sends the mixed regular pictures to the receiving end point (step 610).
10. From this point on, the conference proceeds until either one of the sending endpoints stops sending pictures, or the receiving endpoint breaks connection. In either case and in the preferred embodiment the mixer stops mixing and the conference terminates.

### SECOND EMBODIMENT

This embodiment is concerned with mixing of non synchronized sources in a potentially error prone environment. This environment exists when the frame rates of the sending terminals are not the same (e.g. some of the sending terminals are located in the PAL (Phase Alternate Line) domain, and others in the NTSC (National Television Standard Committee) domain, or when frames may be skipped, or when frames are damaged or lost in transmission. The mixing process is considerably more complex.

In such an environment, during the startup of the conference, the mixer has to signal to the receiving terminal a maximum frame rate that is equal to or higher than the highest frame rate among the rates used by the sending terminals. Alternatively, the mixer can, during the capability exchange, force the sending terminals to a frame rate that is lower than or equal to the frame rate supported by the receiving endpoint.

Once it is established that the receiving endpoint is “faster” or at least “as fast” as the “fastest” sending endpoint in terms of the frame rate, the mixing process operates in the usual fashion, except when the mixer determines that one or more of the incoming pictures is not available in time for mixing. A picture is missing possibly because a) the picture is intentionally not coded by the sending endpoint (skipped picture); b) the picture has not arrived in time due to a lower frame rate at the sending endpoint, or c) the picture is lost in transmission. Cases (a) and (b) can be differentiated from case (c) in the incoming bitstream by the mixer by observing the frame_num in the slice header.

In case (a) or (b), the mixer introduces a single slice into the mixed picture that consist entirely of macroblocks coded in SKIP mode. This forces the receiving endpoint to re-display the same content as in the previous picture. It should be understood that coding a single slice with skipped macroblocks does not constitute a transcoding step and is computationally simple. Alternatively, the mixer simply omits sending the macorblocks for which no data is available. In practice, the omission would lead to a non-compliant bitstream and trigger an error concealment algorithm in the receiving endpoint. Error concealment algorithms are commonly implemented in endpoints.

In case (c), the receiving endpoint has to be informed that a part of the incoming picture, as seen from the receiving endpoint (the outgoing picture of the mixer) has been lost in transit and needs to be concealed. When H.264 is used as the video compression standard, this can preferably be done by the mixer through the generation of a slice covering the appropriate spatial area with no maroblock data, and setting the forbidden_zero_bit in the NAL unit header to 1.

In order to compensate for network jitter and to deal with different frame sizes, the mixer should have buffers of reasonable size. It is preferable that the size of these buffers be chosen in an adaptive manner during the lifetime of the connection, at least taking into account the measured network jitter and the measured variation in picture size.

Non-H.264 Video Compression

When a video compression standard/technology other than H.264 baseline is used, the video mixing methods, according to the present invention, are still applicable provided that:
All endpoints in the conference support the same video compression standard.
The video compression standard/technology must support a mechanism that allows the spatial segmenting of a coded picture in an adequate form.

Currently, one other video compression standard that contains sufficient support for the present invention is ITU-T Rec. H.263, with Annex R enabled and Annex K, sub-mode rectangular slices enabled. Thus, the first and second video bitstreams can be made conforming to H.263 with Slice Structured Mode (SSM, defined in Annex K), sub-mode Rectangular Slices, enabled, and Independent Segment Decoding mode (ISM, defined in Annex R) enabled. An SSM mechanism is used to map the plurality of slices of at least one of said plurality of first bitstreams to at least one of a plurality of non overlapping rectangular spatial areas in said reconstructed second bitstream.

Decomposition of Video Streams in Cascaded MCUs

Cascaded MCUs are used when the output of a mixer (“sending mixer”) of one MCU is fed into at one or more inputs of one or more other MCUs (“intermediate MCUs”). Cascaded MCUs are usually used for large conferences with dozens of participants. However, this technology is also used where privacy is desired. With Cascaded MCUs, many participants of one company can share their private MCU (an “intermediate MCU”), and only the output signal of the intermediate MCU leaves the company's administrative domain.

As illustrated in FIG. 7, the “sending mixer” 730 in the MCU 720 receives two compressed video bitstreams 711, 712 from two sending endpoints 701, 702. The output 722 of the mixer 730 is sent through a network 740 to an intermediate MCU 750. The MCU 750 has a mixer 770 and a decomposer 760. The decomposer 760 is used as a terminator of the compressed video bitstream 722 from the sending mixer 730. Within the MCU 750, the input video stream 722 is decomposed into two video streams 761, 762 conveyed to the mixer 770. The mixer 770 also receives a video bitstream 713 from another sending endpoint 703. The mixer 770 mixes the video streams 761, 762, 713 into a mixed video stream 771 conveyed to a receiving endpoint 780.

As illustrated in FIG. 7, the sending endpoints 701, 702 and the MCU 720 is in Domain A, whereas the sending endpoint 703 and the MCU 750 are in a different Domain B. Domain A can be a company LAN, for example. Domain B can be a LAN of another company, for example. It should be appreciated that one or more MCUs with decomposer in other domains can be used to form a deeper cascade.

Normally, in a cascaded MCU environment, an MCU that receives its video information from another MCU has no standardized means to separate the various sub-pictures in the mixed picture. The present invention allows an MCU to extract the sub-streams in a mixed video stream received from another MCU. For example, the video stream 722 received by the MCU 750 is composed of two bitstreams 711, 712 by the mixer 730 in the MCU 720. With the decomposer 760, the MCU 750 is able to extract the sub-streams 761, 762 in the compressed domain. The sub-streams 761, 762 are separately related to the sub-streams 711, 712. With the sub-streams 761, 762, the mixer 770 can compose the outgoing stream 771 together with the input stream 713 in a more flexible way.

The decomposition process is explained in the following, using FIG. 7 and H.264 standard as an example.
1. The decomposer 760 receives from the sending mixer 730 the picture and sequence parameter sets. The picture parameter set contains H.264 slice group map, which is used to identify the spatial regions of the mixed stream 722 that originated from the various endpoints 701, 702 connected to the sending mixer 730 (or to another cascaded MCU). Signaling support is also used a) to indicate that the stream 722 terminating at the decomposer 760 is generated using a compliant mixer 730, and b) to identify each sub-stream 711, 712 in the mixed stream 722 (e.g. providing real names, caller-Ids, or similar means of identification). The exact nature of the signaling support is outside the scope of the present invention. In order to generate self-contained H.264 coded streams out of the extracted sub-streams 761, 762, the decomposer 760 performs the following steps: Generate a sequence parameter set for each sub-stream 761, 762 as follows: copy the sequence parameter set as received from the mixed bit stream 722, and change a) seq_parameter_set_id to 1, b) pic_width_in_mbs_minus1 to the horizontal size of the spatial representation of the sub-stream 761, 762 measured in units of macroblocks (16 pixels), and c) pic_height_in_map_units_minus1 to the vertical size of the spatial representation of the sub stream measured in units of macroblocks. It should be noted that the size of the spatial representation of each sub stream can be extracted from the slice group map of the incoming picture. Send the generated sequence parameter set to the output streams 761, 762 of the decomposer 760.
2. Generate the picture parameter set for each sub stream 761, 762 as follows: copy the values of the syntax elements present in the picture parameter set as received from the mixed stream 722, and change a) pic_parameter_set_id to 1, b) seq_parameter_set_id to 1, and num_slice_groups_minus1 to 0, then generate the new picture parameter set. Send the generated picture parameter set to the output streams 761, 762 of the decomposer 760.
3. Send an IDR picture containing, for example, a logo to the output streams of the decomposer. Issue a freeze picture request on the output streams 761, 762 of the decomposer 760.
4. Repeat steps 5 to 8 until the connection is terminated: Remove the slice header from the incoming NAL unit. Store its contents and the start of the coded macroblock data in local variables. In the following description, the names of the local variables are chosen according to the name of the syntax elements of H.264.
5. Modify the local variables first_mb_in_slice as follows:
   Let xsize_i be the horizontal size of the spatial region of the reconstructed incoming mixed stream 722, measured in units of macroblocks (16 pixels)
   Let xsize_o be the x horizontal size of the spatial region of the mixed stream 771 to be generated, measured in units of macroblocks (16 pixels)
   Let xpos, ypos be the x and y position, respectively, of the top, left macroblock of the “window” in the spatial representation of the outgoing streams 761, 762, into which the spatial representation of the incoming stream 722 should be copied.
   Let mbpos_i be the previous value of first_mb_in_slice in the incoming mixed bit stream 722

The / symbol denotes division with truncation, the % symbol denotes the modulo operation, text in a line after the // symbol denotes a comment (c++ syntax)

| first_mb_in_slice = | |
|---|---|
| (−ypos * xsize_o) + | // macroblocks in the lines above the |
| “window” | |

| | |
|---|---|
| (mbpos_i / xsize_i) * xsize_o + | // lines in the “window” |

| | |
|---|---|
| (−xpos) + | // macrobock columns left of the “window” |

| | |
|---|---|
| (mbpos_i % xsize_i); | // columns in the “window” |

6. Set pic_parameter_set_id to 1
7. Using the modified local variables, generate a new slice header and concatenate it with the macroblock data, as stored before in step 5. Send the modified slice to the output of the decomposer. It should be noted that the local variable frame_num has not been changed during the decomposition process. This helps identifying (at the device connected to the output of the decomposer) any lost pictures of the mixed stream on the transmission path between the sending mixer and the decomposer.

For decomposing the incoming video 722 into substreams 761, 762, the decomposer 760 may have a software program similar to the software program 422 in the mixer (see FIG. 4) to modify the local variables such as first_mb_in_slice and to change the values of the syntax elements. Furthermore, the software program 422 can also have pseudo codes for carrying out one or more of the signaling steps as shown in FIG. 6.

It should be appreciated by a person skilled in the art that a comparable process can be used for Cascade MCUs based on H.263 w/Annex R, K (rectangular slices sub-mode).

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method of video mixing in compressed domain for combining a plurality of first video bitstreams into at least one second video bitstream having a plurality of frames, each of the first bitstreams having a plurality of corresponding frames, said method comprising:
dividing each of the first video bitstreams into a plurality of slices, each of the slices having a slice header including a plurality of header fields;
changing one or more of the plurality of header fields in the slice header for providing a changed slice header in at least some of the slices;
providing a changed slice for each of said at least some of the slices; and
generating the second video bitstream based on the changed slices, wherein the changed slice for use in each of the frames in the second video bitstream is corresponding to a same frame in the plurality of corresponding frames in the first video bitstreams.

2. The method according to claim 1, wherein said one or more of the plurality of header fields comprise a frame_num header field.

3. The method according to claim 1, wherein said one or more of the plurality of header fields comprise a first_mb_in_slice header field and wherein first_mb_in_slice has a value indicative of location of said each slice in a spatial region in a spatial representation of the first video bitstreams.

4. The method according to claim 3, wherein the first_mb_in_slice header field is changed by changing said value of first_mb_in_slice to a new value indicative of the location of the corresponding changed slice in a spatial region in a spatial representation of the second video bitstream.

5. The method according to claim 4, wherein said new value of first_mb_in_slice is calculated as follows:
first_mb_in_slice=ypos*xsize_o+(mbpos_i/xsize_i)*xsize_o+xpos+(mbpos_i % xsize_i),
wherein
/ denotes division by truncation;
% denotes a modulo operator;
xsize_i denotes a horizontal size of the spatial region in the spatial representation of the first video bitstream;
xsize_o denotes a horizontal size of the spatial region in the spatial representation of the second video bitstream;
xpos, ypos denote coordinates of a location in the spatial representation of the second video bitstream for placing said spatial region in the spatial representation of the first video bistream; and
mbpos_i denotes said value of first_mb_in_slice.

6. The method according to claim 1, further comprising
transforming the second video bitstream for providing a spatial representation of the second video bitstream.

7. The method according to claim 1, further comprising
identifying the slices in the first video bitstreams so as to allow the changed slices in the same frame to be combined into one of the frames in the second bitstream.

8. The method of claim 1, wherein one or more of the first video bistreams comprise a mixed bitstream composed from a plurality of further video bistreams, said method further comprising:
decomposing the mixed bitstream for providing a plurality of component video bitstreams, each of the component video bitstreams corresponding to one of the further video bistreams, so as to allow the component video bitstreams to be combined with one or more other first video bitstreams for generating the second video bitstream.

9. The method according to claim 1, wherein said generating comprises mapping the plurality of slices of at least one of said plurality of first video bitstreams to at least one of a plurality of non-overlapping rectangular areas in a spatial representation of the second video bitstream.

10. The method according to claim 9, wherein said first and second video bitstreams conform to H.264.

11. The method according to claim 9, wherein said mapping is based on H.264's slice group concept.

12. The method according to claim 1, wherein said first and second video bitstreams conform to H.263 with Slice Structured Mode (SSM, defined in Annex K), sub-mode Rectangular Slices, enabled, and Independent Segment Decoding mode (ISM, defined in Annex R) enabled.

13. The method according to claim 12, wherein an SSM mechanism is used to map the plurality of slices of at least one of said plurality of first bitstreams to at least one of a plurality of non overlapping rectangular spatial areas in said reconstructed second bitstream.

14. A procedure for video mixing in compressed domain for combining a plurality of first video bitstreams into at least one second video bistream, each of the first video bitstreams and the second video bitstream having an equivalent spatial representation, wherein the second video bitstream comprises a plurality of second slices, each second slice having a slice header including a plurality of header fields, and wherein each of the first video bitstreams comprises a plurality of first slices, each first slice having a slice header including a plurality of header fields, said procedure comprising the steps of:
parsing the slice header of the first slices for obtaining values in the plurality of header fields, wherein one of the values is indicative of a spatial region in the spatial representation of the corresponding first video bitstream;
modifying said one of the values for providing a new value indicative of a spatial region in the spatial representation of the second video bitstream;
generating a new slice header based on the new value for providing a modified first slice; and
combining the first video bitstreams into said one second video bitstream such that each of the second slice in the second video bitstream is composed based on the modified first slice of each of first video bitstreams.

15. The procedure according to claim 14, wherein said one of the values is first_mb_in_slice indicative of location of a first slice in the spatial region in the spatial representation of the corresponding first videostream.

16. The procedure according to claim 15, wherein the new value of first_mb_in_slice is calculated as follows:
first_mb_in_slice=ypos*xsize_o+(mbpos_i/xsize_i)*xsize_o+xpos+(mbpos_i % xsize_i),
wherein
/ denotes division by truncation;
% denotes a modulo operator;
xsize_i denotes a horizontal size of the spatial region in the spatial representation of the first video bitstream;
xsize_o denotes a horizontal size of the spatial region in the spatial representation of the second video bitstream;
xpos, ypos denote coordinates of a location in the spatial representation of the second video bitstream for placing said spatial region in the spatial representation of the first video bistream; and
mbpos_i denotes said value of first_mb_in_slice.

17. The procedure according to claim 14, wherein one or more of the first video bistreams comprise a mixed bitstream composed from a plurality of further video bistreams, said procedure further comprising the step of:
decomposing the mixed bitstream for providing a plurality of component video bitstreams, each of the component video bitstreams corresponding to one of the further video bistreams, so as to allow the component video bitstreams to be combined with one or more other first video bitstreams for generating the second video bitstream.

18. A video mixer operatively connected to a plurality of sending endpoints to receive therefrom a plurality of first video bitstreams for combining in compressed domain the plurality of first video bitstreams into at least one second video bitstream having a plurality of frames, each of the first bitstreams having a plurality of slices in a plurality of corresponding frames, each slice having a slice header including a plurality of header fields, said mixer comprising:
a mechanism for changing one or more of the plurality of header fields in the slice header for providing a changed slice in at least some of the slices based on the changed one or more header fields; and
a mechanism for combining the changed slices for providing the second video bitstream, wherein the changed slices for use in each of the frames in the second video bistream is corresponding to a same frame in the plurality of corresponding frames in the first video bitstreams.

19. The video mixer according to claim 18, wherein said one or more of the plurality of header fields comprise a first_mb_in_slice header field and wherein first_mb_in_slice has a value indicative of location of said slice in a spatial region in a spatial representation of the first video bitstreams.

20. The video mixer according to claim 19, wherein the first_mb_in_slice header field is changed by changing said value of first_mb_in_slice to a new value indicative of location of said changed slice in a spatial region in a spatial representation of the second video bitstream.

21. The video mixer according to claim 20, wherein said new value of first_mb_in_slice is calculated as follows:
first_mb_in_slice=ypos*xsize_o+(mbpos_i/xsize_i)*xsize_o+xpos+(mbpos_i % xsize_i),
wherein
/ denotes division by truncation;
% denotes a modulo operator;
xsize_i denotes a horizontal size of the spatial region in the spatial representation of the first video bitstream;
xsize_o denotes a horizontal size of the spatial region in the spatial representation of the second video bitstream;
xpos, ypos denote coordinates of a location in the spatial representation of the second video bitstream for placing said spatial region in the spatial representation of the first video bistream; and
mbpos_i denotes said value of first_mb_in_slice.

22. The video mixer according to claim 18, wherein said combining comprises mapping the plurality of slices of at least one of said plurality of first video bitstreams to at least one of a plurality of non-overlapping rectangular areas in a spatial representation of the second video bitstream.

23. A signaling method for use in a communication network in support of the method as claimed in claim 1, wherein the communication network comprises a plurality of sending endpoints to provide the plurality of first video bitstreams and at least one receiving endpoint to receive said at least one second video bitstream, said signaling method comprising the steps of:
Step 1: negotiating a picture format for use by the receiving endpoint and the sending endpoints;
Step 2: sending control information to the receiving endpoint in order to prepare the receiving endpoint for the receiving of said second video bitstream.

24. The signaling method according to claim 23, wherein said negotiating in Step 1 comprises:
generating a layout of the picture format for the receiving endpoint;
identifying at least one picture format based on said layout for each of the plurality of sending endpoints; and
informing the plurality of sending endpoints of said identified picture format for each of the plurality of sending endpoints.

25. The signaling method according to claim 24, wherein said negotiating in Step 1 further comprises:
receiving one negotiated picture format from each of the plurality of the sending endpoints in response to said informing.

26. The signaling method according to claim 25, wherein each of the plurality of sending endpoints provides a parameter set containing information indicative of said one negotiated picture format, and wherein said sending in Step 2 further comprises the step of
generating an output parameter set based on said information provided by each of the plurality of sending endpoints so as to provide the control information to the receiving endpoint based on the output parameter set.

27. A software product embedded in a computer readable medium for use in compressed domain video mixing for combining a plurality of first video bitstreams into at least one second video bitstream having a plurality of frames, each of the first bitstreams having a plurality of corresponding frames, wherein each of the first video bitstreams is divided into a plurality of slices, each of the slices having a slice header including a plurality of header fields, said software product comprising a plurality of codes for carrying out:
changing one or more of the plurality of header fields in the slice header for providing a changed slice header in at least some of the slices;
providing a changed slice for each of said at least some of the slices; and
generating the second video bitstream based on the changed slices, wherein the changed slice for use in each of the frames in the second video bitstream is corresponding to a same frame in the plurality of corresponding frames in the first video bitstreams, and wherein said one or more of the plurality of header fields comprise a first_mb_in_slice header field having a value indicative of location of said each slice in a spatial region in a spatial representation of the first video bitstreams.

28. The software product of claim 27, wherein the first_mb_in_slice header field is changed by changing said value to a new value indicative of the location of the corresponding changed slice in a spatial region in a spatial representation of the second video bitstream, said software product further comprising codes for calculating said new value as follows:
first_mb_in_slice=ypos*xsize_o+(mbpos_i/xsize_i)*xsize_o+xpos+(mbpos_i % xsize_i),
wherein
/ denotes division by truncation;
% denotes a modulo operator;
xsize_i denotes a horizontal size of the spatial region in the spatial representation of the first video bitstream;
xsize_o denotes a horizontal size of the spatial region in the spatial representation of the second video bitstream;
xpos, ypos denote coordinates of a location in the spatial representation of the second video bitstream for placing said spatial region in the spatial representation of the first video bistream; and
mbpos_i denotes said value of first_mb_in_slice.

29. The software product of claim 27, further comprising codes for
identifying the slices in the first video bitstreams so as to allow the changed slices in the same frame to be combined into one of the frames in the second bitstream.

30. The software product of claim 27, wherein said compressed domain video mixing is carried out in a multi-point control unit operatively connected to a plurality of sending endpoints providing the plurality of first video bitstreams and to a receiving endpoint receiving the second video bitstream, said software product further comprising codes for
generating a layout of a picture format for the receiving endpoint;
identifying at least one further picture format for each of the plurality of sending endpoints based on the layout; and
informing the plurality of sending endpoints of said identified picture format for each of the plurality of sending endpoints.

31. The software product of claim 30, wherein each of the plurality of sending endpoints provides a parameter set in response to said informing, the parameter set containing information indicative of one negotiated picture format from each of the plurality of the sending endpoints, said software product further comprising codes for
generating an output parameter set based on said information provided by each of the plurality of sending endpoints so as to provide the control information to the receiving endpoint based on the output parameter set.

32. The software product of claim 27, wherein one or more of the first video bistreams comprise a mixed bitstream composed from a plurality of further video bistreams, said software product further comprising codes for
decomposing the mixed bitstream for providing a plurality of component video bitstreams, each of the component video bitstreams corresponding to one of the further video bistreams, so as to allow the component video bitstreams to be combined with one or more other first video bitstreams for generating
